(19) United States
(12) Patent Application Publication
(10) Pub. No.: US 2017/0327601 A1
(43) Pub. Date: Nov. 16, 2017

(54) RUBBER COMPOSITION, AND PNEUMATIC TIRE AND CONVEYER BELT EACH MANUFACTURED USING SAME

(71) Applicant: THE YOKOHAMA RUBBER CO., LTD., MINATO-KU, TOKYO (JP)

(72) Inventors: Manabu KATO, HIRATSUKA-CITY, KANAGAWA (JP); Ryota TAKAHASHI, HIRATSUKA-CITY, KANAGAWA (JP); Takahiro OKAMATSU, HIRATSUKA-CITY, KANAGAWA (JP); Yoshiaki KIRINO, HIRATSUKA-CITY, KANAGAWA (JP)

(21) Appl. No.: 15/535,579

(22) PCT Filed: Dec. 15, 2015
(86) PCT No.: PCT/JP2015/085030

§ 371 Date: Jun. 13, 2017

(30) Foreign Application Priority Data
Dec. 15, 2014 (JP) 2014-253202

(51) Int. Cl. C08C 19/22; C08L 15/00; B60C 1/00; C08L 9/06; B65G 15/34

(52) U.S. Cl. CPC C08C 19/22; C08L 9/06; B65G 15/34; B60C 1/0016; C08L 15/00; B65G 2812/02198; C08L 2205/02; C08L 2205/035

(57) ABSTRACT

The present invention is to provide: a rubber composition which has excellent wet grip performance and also has excellent wear resistance while maintaining high elongation; and a pneumatic tire and a conveyer belt each of which is manufactured using the rubber composition. The present invention provides: a rubber composition containing a modified diene rubber, in the modified rubber, from 0.02 to 4 mol % of double bonds contained in a diene rubber being modified into hydroxy groups by reacting at least one type of diene rubber selected from the group consisting of styrene butadiene rubbers, butadiene rubbers, and nitrile butadiene rubbers with a hydroxy group-containing nitrone compound having both a hydroxy group and a nitrone group; and a pneumatic tire and a conveyer belt each of which is manufactured using the rubber composition.

### TECHNICAL FIELD

The present invention relates to a rubber composition, and a pneumatic tire and a conveyer belt each manufactured using such a rubber composition.

### BACKGROUND ART

Conventionally, modified polymers modified with a nitrone compound have been proposed.

For example, Patent Document 1 proposes a modified polymer modified with two or more types of nitrones containing (A) a nitrone having at least one carboxy group and (B) a nitrone having no carboxy group.

Furthermore, recently, reduction in weight of tires has been studied from the perspective of environmental conservation. When the volume of a cap tread portion is reduced to reduce the weight of a tire, wear resistance of the cap tread portion needs to be enhanced.

For example, to enhance wear resistance and the like, Patent Document 2 proposes a pneumatic tire formed by using, in a tire member, a rubber composition containing a rubber component formed from at least one type selected from the group consisting of a natural rubber and a diene synthetic rubber, a silica having a nitrogen adsorption specific surface area of 210 to 260 m²/g and a dibutyl phthalate oil absorption of 200 to 260 mL/100 g, and at least one type of compound selected from aromatic polycarboxylic acid derivatives represented by a particular Formula (I), the compounded amount of the aromatic polycarboxylic acid derivative being from 0.5 to 4.0 parts by weight per 100 parts by weight of the rubber component (Claim 1). Furthermore, Patent Document 2 discloses that the aromatic polycarboxylic acid derivative is formed from at least one type of derivative selected from the group consisting of phthalic acid, trimellitic acid, pyromellitic acid, and anhydrides thereof (Claim 2).

### CITATION LIST

### Patent Literature

Patent Document 1: Japanese Unexamined Patent Application Publication No. 2014-101400A

Patent Document 2: Japanese Unexamined Patent Application Publication No. 2000-296702A

### SUMMARY OF INVENTION

### Technical Problem

Among these, when the inventors of the present invention prepared a rubber composition containing a modified polymer modified with a nitrone compound in accordance with Patent Document 1, it was found that wet grip performance of such a rubber composition might be enhanced.

Furthermore, when a rubber composition containing a compound having a carboxy group or the like was prepared in accordance with Patent Document 2, it was found that, with such a rubber composition, it was difficult to achieve high elongation and excellent wear resistance at the same time. Furthermore, it was also found that wet grip performance was somewhat poor.

Thus, an objective of the present invention is to provide a rubber composition which has excellent wet grip performance and also has excellent wear resistance while maintaining high elongation.

### Solution to Problem

As a result of diligent research to solve the problems described above, the inventors of the present invention found that predetermined effects were achieved by a rubber composition containing a hydroxy group-containing modified diene rubber, in which a particular amount of double bonds contained in a particular diene rubber is modified with hydroxy groups.

Furthermore, the inventors of the present invention found that even better predetermined effects were achieved by a rubber composition further containing a particular functional group-containing reactive compound for such a modified diene rubber, and thus completed the present invention.

The present invention is based on the findings described above and the like and, specifically, solves the problems described above by the following features.

1. A rubber composition containing a modified diene rubber, in the modified rubber, from 0.02 to 4 mol % of double bonds contained in a diene rubber being modified into hydroxy groups by reacting at least one type of diene rubber selected from the group consisting of styrene butadiene rubbers, butadiene rubbers, and nitrile butadiene rubbers with a hydroxy group-containing nitrone compound having both a hydroxy group and a nitrone group.

2. The rubber composition according to 1 above, further containing:

a polymer containing from 10 to 90 mass % of the modified diene rubber, and

a reactive compound having a plurality of functional groups that can react with the hydroxy group contained in the modified diene rubber in each molecule; where

a molar ratio of the functional group to the hydroxy group contained in the modified diene rubber is from 3 to 25.

3. The rubber composition according to 2 above, where the functional group is at least one type selected from the group consisting of epoxy groups and carboxy groups.

4. The rubber composition according to 2 or 3 above, where a molecular weight of the reactive compound is 3000 or less.

5. The rubber composition according to any one of 1 to 4 above, where the hydroxy group-containing nitrone compound is at least one type selected from the group consisting of

N-phenyl-α-(4-hydroxyphenyl)nitrone,

N-phenyl-α-(3-hydroxyphenyl)nitrone,

N-phenyl-α-(2-hydroxyphenyl)nitrone,

N-(4-hydroxyphenyl)-α-phenylnitrone,

N-(3-hydroxyphenyl)-α-phenylnitrone, and

N-(2-hydroxyphenyl)-α-phenylnitrone.

6. A pneumatic tire including the rubber composition described in any one of 1 to 5 above.

7. A conveyor belt including the rubber composition described in any one of 1 to 5 above.

### Advantageous Effects of Invention

According to the present invention, a rubber composition which has excellent wet grip performance and also has excellent wear resistance while maintaining high elongation; and a pneumatic tire and a conveyer belt each of which manufactured using the rubber composition can be provided.

### BRIEF DESCRIPTION OF DRAWING

FIG. 1 is a partial cross-sectional schematic view of a tire that illustrates one embodiment of a pneumatic tire of the present invention.

### DESCRIPTION OF EMBODIMENTS

Embodiments of the present invention are described in detail below.

Note that, in the present specification, numerical ranges indicated using “(from) . . . to . . . ” include the former number as the lower limit value and the later number as the upper limit value.

Furthermore, in the present specification, when a component contains two or more types of substances, the content of the component indicates the total content of the two or more types of substances.

### Rubber Composition

The rubber composition of the present invention is

a rubber composition containing a modified diene rubber, in the modified rubber, from 0.02 to 4 mol % of double bonds contained in a diene rubber being modified into hydroxy groups by reacting at least one type of diene rubber selected from the group consisting of styrene butadiene rubbers, butadiene rubbers, and nitrile butadiene rubbers with a hydroxy group-containing nitrone compound having both a hydroxy group and a nitrone group.

It is conceived that predetermined effects can be obtained since the rubber composition of the present invention has the configuration described above. Although the reason for this is unknown, the reason is presumed to be as follows.

It is conceived that, by allowing the modified diene rubber contained in the rubber composition of the present invention to have a hydroxy group, the hydroxy group forms a hydrogen bond in the molecule and/or in between molecules of the modified diene rubber, and superior predetermined effects are achieved compared to those of a rubber composition containing another modified diene rubber.

When the rubber composition of the present invention further contains a filler, it is conceived that, by allowing the hydroxy group to interact with the functional group of the filler interface, superior predetermined effects are achieved compared to those of a rubber composition containing another modified diene rubber.

Furthermore, when the rubber composition of the present invention further contains a reactive compound having a plurality of functional groups that can react with the hydroxy group in each molecule, by allowing the plurality of functional groups to react with the hydroxy group contained in the modified diene rubber, another crosslinking that is different from the crosslinking due to sulfur can be formed, and a larger number of crosslinking points can be formed compared to the case where the predetermined reactive compound is not contained.

The inventors of the present invention presume that, due to the presence of the crosslinking formed by the reactive compound as described above, even better predetermined effects are achieved.

Each of the components contained in the rubber composition of the present invention will be described in detail below.

### Modified Diene Rubber

The modified diene rubber contained in the rubber composition of the present invention is

a modified diene rubber, in the modified rubber, from 0.02 to 4 mol % of double bonds contained in a diene rubber being modified into hydroxy groups by reacting at least one type of diene rubber (raw material rubber) selected from the group consisting of styrene butadiene rubbers, butadiene rubbers, and nitrile butadiene rubbers with a hydroxy group-containing nitrone compound having both a hydroxy group and a nitrone group.

The modified diene rubber has double bonds derived from the diene rubber and the hydroxy group derived from the hydroxy group-containing nitrone compound.

In the reaction described above, the double bond contained in the raw material rubber can be modified into a hydroxy group by allowing the double bond to react with the hydroxy group-containing nitrone compound.

In the present invention, the conversion rate (degree of modification) of all the double bonds contained in the raw material rubber into hydroxy groups is from 0.02 to 4 mol %, preferably from 0.1 to 2 mol %, and more preferably from 0.5 to 1.5 mol %.

The degree of modification was calculated from a value obtained by performing ¹H-NMR (nuclear magnetic resonance) analysis (CDCl₃, 400MHz, TMS: tetramethylsilane), using CDCl₃ as a solvent, for raw material rubber before the modification (at least one type of diene rubber selected from the group consisting of styrene butadiene rubbers, butadiene rubbers, and nitrile butadiene rubbers) and the modified diene rubber obtained after the modification to measure peak areas assigned to two protons adjacent to a hydroxy group.

### Diene Rubber

In the present invention, the diene rubber (raw material rubber) used during the production of the modified diene rubber is at least one type selected from the group consisting of styrene butadiene rubbers (SBR), butadiene rubbers (BR), and nitrile butadiene rubbers (NBR).

The raw material rubber is not particularly limited as long as the raw material rubber is at least one type of diene rubber selected from the group consisting of styrene butadiene rubbers, butadiene rubbers, and nitrile butadiene rubbers. Note that the raw material rubber has a double bond derived from butadiene. The double bond is not particularly limited. Examples thereof include vinyl groups and vinylene groups.

The weight average molecular weight of the raw material rubber is preferably 500000 or greater, and more preferably from 500000 to 800000. In the present invention, the weight average molecular weight is a value based on a measured value obtained by gel permeation chromatography (GPC) measured based on calibration with polystyrene standard using tetrahydrofuran as a solvent.

When the raw material rubber is SBR, the amount of styrene is preferably 30 mass % or greater, and more preferably from 30 to 40 mass %. Note that the amount of styrene of styrene butadiene rubber refers to the content (mass %) of the styrene unit in the styrene butadiene rubber. In the present invention, the amount of styrene was measured by infrared spectroscopy (the Hampton method).

### Hydroxy Group-Containing Nitrone Compound

The hydroxy group-containing nitrone compound used during the production of the modified diene rubber is not particularly limited as long as the hydroxy group-containing nitrone compound is a compound having a hydroxy group and a nitrone group represented by Formula (1) below.

The number of the hydroxy groups contained in one molecule of the hydroxy group-containing nitrone compound is 1 or more, preferably from 1 to 10, and more preferably from 1 to 4.

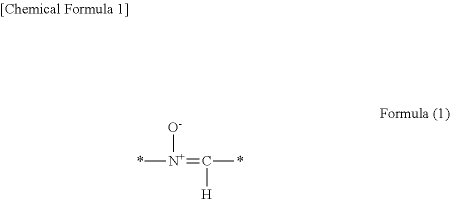 [SMILES: */C=[N+](/*)[O-]]

In Formula (1), * indicates a bond position.

The hydroxy group-containing nitrone compound described above is preferably a compound represented by Formula (2) below.

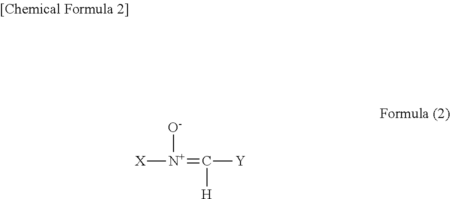

In Formula (2) above, X and Y each independently represent an aliphatic hydrocarbon group, an aromatic hydrocarbon group, an aromatic heterocycle group, or a combination of these, and X and/or Y have hydroxy group(s).

Examples of the aliphatic hydrocarbon group represented by X or Y include alkyl groups, cycloalkyl groups, and alkenyl groups.

Examples of the alkyl group include a methyl group, an ethyl group, an n-propyl group, an isopropyl group, an n-butyl group, an isobutyl group, a sec-butyl group, a tert-butyl group, an n-pentyl group, an isopentyl group, a neopentyl group, a tert-pentyl group, a 1-methylbutyl group, a 2-methylbutyl group, a 1,2-dimethylpropyl group, an n-hexyl group, an n-heptyl group, and an n-octyl group. Among these, alkyl groups having from 1 to 18 carbons are preferable, and alkyl groups having from 1 to 6 carbons are more preferable.

Examples of the cycloalkyl group include a cyclopropyl group, a cyclobutyl group, a cyclopentyl group, and a cyclohexyl group. Among these, cycloalkyl groups having from 3 to 10 carbons are preferable, and cycloalkyl groups having from 3 to 6 carbons are more preferable.

Examples of the alkenyl group include a vinyl group, a 1-propenyl group, an allyl group, an isopropenyl group, a 1-butenyl group, and a 2-butenyl group. Among these, alkenyl groups having from 2 to 18 carbons are preferable, and alkenyl groups having from 2 to 6 carbons are more preferable.

Examples of the aromatic hydrocarbon group represented by X or Y include aryl groups, and aralkyl groups.

Examples of the aryl group include a phenyl group, a naphthyl group, an anthryl group, a phenanthryl group, and a biphenyl group. Among these, aryl groups having from 6 to 14 carbons are preferable, aryl groups having from 6 to 10 carbons are more preferable, and a phenyl group and a naphthyl group are even more preferable.

Examples of the aralkyl group include a benzyl group, a phenethyl group, and a phenylpropyl group. Among these, aralkyl groups having from 7 to 13 carbons are preferable, aralkyl groups having from 7 to 11 carbons are more preferable, and a benzyl group is even more preferable.

Examples of the aromatic heterocycle group represented by X or Y include a pyrrolyl group, a furyl group, a thienyl group, a pyrazolyl group, an imidazolyl group (an imidazole group), an oxazolyl group, an isoxazolyl group, a thiazolyl group, an isothiazolyl group, a pyridyl group (a pyridine group), a furan group, a thiophene group, a pyridazinyl group, a pyrimidinyl group, and a pyrazinyl group. Among these, pyridyl groups are preferable.

X and/or Y have hydroxy group(s). The hydroxy group can bond to an aliphatic hydrocarbon group, an aromatic hydrocarbon group, an aromatic heterocycle group, or a combination of these (hereinafter, these are also referred to as “aliphatic hydrocarbon group” and the like).

The hydroxy group-containing nitrone compound may contain another substituent besides the hydroxy group. Such a substituent is not particularly limited, and examples thereof include an alkyl group having from 1 to 4 carbons, an amino group, a nitro group, a carboxy group, a sulfonyl group, an alkoxy group, and a halogen atom. The substituent can bond to the aliphatic hydrocarbon group and the like described above.

Specific examples of the hydroxy group-containing nitrone compound include compounds represented by Formula (3) below.

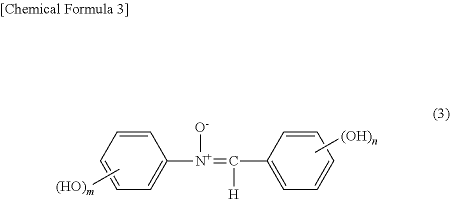

In Formula (3), m and n each independently represent an integer from 0 to 5, and the sum of m and n is 1 or greater.

The integer represented by m is preferably an integer from 0 to 2, and more preferably an integer from 0 or 1, because solubility in a solvent during hydroxy group-containing nitrone compound synthesis becomes better, thereby making the synthesis easier.

The integer represented by n is preferably an integer from 0 to 2, and more preferably an integer from 0 or 1, because solubility in a solvent during hydroxy group-containing nitrone compound synthesis becomes better, thereby making the synthesis easier.

Furthermore, the sum of m and n (m+n) is preferably from 1 to 4, and more preferably 1 or 2.

Examples of the hydroxy group-containing nitrone compound is at least one type selected from the group consisting of

N-phenyl-α-(4-hydroxyphenyl)nitrone,

N-phenyl-α-(3-hydroxyphenyl)nitrone,

N-phenyl-α-(2-hydroxyphenyl)nitrone,

N-(4-hydroxyphenyl)-α-phenylnitrone,

N-(3-hydroxyphenyl)-α-phenylnitrone, and

N-(2-hydroxyphenyl)-α-phenylnitrone.

The method of synthesizing the hydroxy group-containing nitrone compound is not particularly limited, and conventionally known methods can be used. For example, a hydroxy group-containing nitrone compound having a nitrone group is obtained by stirring a compound having a hydroxyamino group (—NHOH) and a compound having an aldehyde group (—CHO) at a molar ratio of hydroxyamino group to aldehyde group (—NHOH/—CHO) of from 1.0 to 1.5 in the presence of an organic solvent (e.g. methanol, ethanol, and tetrahydrofuran) at room temperature for 1 to 24 hours to allow the both groups to react. The compound having a hydroxyamino group and/or the compound having an aldehyde group needs to have a hydroxy group.

The used amount of the hydroxy group-containing nitrone compound is preferably from 0.1 to 10 parts by mass, and more preferably from 0.2 to 5 parts by mass, per 100 parts by mass of the diene rubber as the raw material rubber.

A single hydroxy group-containing nitrone compound can be used or a combination of two or more types of hydroxy group-containing nitrone compounds can be used.

In the present invention, as the nitrone compound used during the production of the modified diene rubber, another nitrone compound besides the hydroxy group-containing nitrone compound may be used in combination. Examples of the nitrone compound include carboxynitrones having a carboxy group and a nitrone group.

Furthermore, in the present invention, an example of a preferable aspect is one in which the nitrone compound used during the production of the modified diene rubber is only hydroxy group-containing nitrone compound(s).

### Production of Modified Diene Rubber

The modified diene rubber can be produced by reacting at least one type of diene rubber selected from the group consisting of styrene butadiene rubbers, butadiene rubbers, and nitrile butadiene rubbers with a hydroxy group-containing nitrone compound having both a hydroxy group and a nitrone group. Specific examples thereof include a method in which the diene rubber and the hydroxy group-containing nitrone compound are mixed in a condition at 100 to 200° C. for 1 to 30 minutes.

In the present invention, in the modified diene rubber, the backbone of the main chain thereof is at least one type selected from the group consisting of styrene butadiene rubbers, butadiene rubbers, and nitrile butadiene rubbers, and the modification group contains a hydroxy group. The hydroxy group contained in the modified diene rubber is formed by the hydroxy group-containing nitrone compound. The content of the hydroxy group in the modified diene rubber is from 0.02 to 4 mol % relative to the total amount of the hydroxy group described above and the double bonds contained in the modified diene rubber.

A single modified diene rubber can be used or a combination of two or more types of modified diene rubbers can be used.

### Polymer

An example of a preferable aspect is one in which the rubber composition of the present invention contains a polymer containing from 10 to 90 mass % of the modified diene rubber.

In this case, the polymer contained in the rubber composition of the present invention contains a modified diene rubber and a polymer besides the modified diene rubber.

The content of the modified diene rubber is preferably from 10 to 90 mass %, and more preferably from 20 to 70 mass %, relative to the total amount of the polymer. The upper limit of the content of the modified diene rubber can be set to 50 mass % or less relative to the total amount of the polymer. The lower limit of the content of the modified diene rubber can be set to 30 mass % or greater relative to the total amount of the polymer.

The polymer besides the modified diene rubber contained in the polymer is preferably a rubber, and more preferably a diene rubber. Examples of the diene rubber include a natural rubber (NR), an isoprene rubber (IR), a butadiene rubber (BR), an aromatic vinyl-conjugated diene copolymer rubber (e.g. styrene-butadiene rubber (SBR)), a nitrile butadiene rubber (NBR; acrylonitrile butadiene rubber), a butyl rubber (IIR), a halogenated butyl rubber (e.g. Br-IIR, Cl-IIR), and a chloroprene rubber (CR).

Among these, the polymer besides the modified diene rubber is preferably all of or at least one type selected from the group consisting of the natural rubbers, styrene butadiene rubbers, and butadiene rubbers. The natural rubbers, styrene butadiene rubbers, and butadiene rubbers are not particularly limited. Examples thereof include conventionally known rubbers.

### Reactive Compound

An example of a preferable aspect is one in which the rubber composition of the present invention further contains a reactive compound having a plurality of functional groups that can react with the hydroxy group in each molecule.

The functional group contained in the reactive compound can react with the hydroxy group contained in the modified diene rubber.

The functional group is preferably at least one type selected from the group consisting of epoxy groups and carboxy groups.

The functional group can bond to a hydrocarbon group that may have a substituent.

The hydrocarbon group is not particularly limited. Examples thereof include aliphatic hydrocarbon groups (that maybe any of straight chain, branched chain, or cyclic form), aromatic hydrocarbon groups, and combinations thereof. The hydrocarbon group may have an unsaturated bond.

The number of the functional groups contained in one molecule of the reactive compound is preferably from 2 to 25, and more preferably from 2 to 18, from the perspective of achieving predetermined effects even better. The lower limit of the number of the functional groups may be set to 3 or more.

Examples of the reactive compound include epoxy resins and carboxylic acid compounds.

Examples of the epoxy resin include bisphenol A-type epoxy resins, diaminodiphenylmethane-type epoxy resins, and dicyclopentadiene-type epoxy resins.

Examples of the carboxylic acid compound include aliphatic dicarboxylic acids having from 4 to 10 carbons, such as adipic acid and sebacic acid; and aromatic dicarboxylic acids having from 8 to 10 carbons, such as terephthalic acid, isophthalic acid, and phthalic acid. The carboxylic acid compound may be a carboxylic anhydride.

Among these, an aromatic dicarboxylic acid is preferable, and terephthalic acid is more preferable.

The molecular weight of the reactive compound is preferably 3000 or less, more preferably from 100 to 1000, and even more preferably from 100 to 500. Note that, when the reactive compound is an oligomer or a high molecular weight compound, the molecular weight of the reactive compound may be the number average molecular weight in the present invention. In the present invention, the number average molecular weight of the reactive compound is a value obtained by gel permeation chromatography (GPC) measured based on calibration with polystyrene standard using tetrahydrofuran as a solvent.

A single reactive compound can be used or a combination of two or more types of reactive compounds can be used.

The amount of the reactive compound is preferably from 0.5 to 6 parts by mass, and more preferably from 1 to 3 parts by mass, per 100 parts by mass of the modified diene rubber.

In the present invention, the molar ratio (functional group/hydroxy group) of the functional group relative to the hydroxy group contained in the modified diene rubber is preferably from 3 to 25, and more preferably from 3 to 18.

When the functional group is a carboxy group, the molar ratio of the functional group (carboxy group)/hydroxy group is preferably from 8 to 11, and more preferably from 8.5 to 10.

Furthermore, when the functional group is an epoxy group, the molar ratio of the functional group (epoxy group)/hydroxy group is preferably from 5 to 23, and more preferably from 6 to 12.

The rubber composition of the present invention may further contain additives within a scope that does not inhibit the effect or purpose thereof. Examples of the additives include additives that are typically used in rubber compositions, such as silicas, carbon blacks, silane coupling agents (e.g. Si69, manufactured by Evonic Degussa Corporation, and Si363, manufactured by Evonic Degussa Corporation), zinc oxide (flower of zinc), stearic acid, anti-aging agents, processing aids, waxes, oils, liquid polymers, terpene resins, thermosetting resins, vulcanizing agents (e.g. sulfur), and vulcanization accelerators.

### Silica

The rubber composition of the present invention preferably further contains a silica.

The silica is not particularly limited, and any conventionally known silica that is blended in rubber compositions for use in tires or the like can be used.

Specific examples of the silica include wet silica, dry silica, fumed silica, and diatomaceous earth. One type of the silica may be used alone, or two or more types of the silicas may be used in combination.

In the present invention, the silica is preferably wet silica from the perspective of reinforcing property of rubber.

The content of the silica is not particularly limited; however, the content is preferably from 30 to 400 parts by mass, more preferably from 50 to 300 parts by mass, and even more preferably from 100 to 250 parts by mass, per 100 parts by mass of the modified diene rubber.

### Carbon Black

The rubber composition of the present invention preferably further contains a carbon black.

The carbon black is not particularly limited and, for example, carbon blacks of various grades, such as SAF-HS, SAF, ISAF-HS, ISAF, ISAF-LS, IISAF-HS, HAF-HS, HAF, HAF-LS, and FEF, can be used.

The content of the carbon black is not particularly limited, but is preferably from 30 to 140 parts by mass, and more preferably from 50 to 120 parts by mass, per 100 parts by mass of the modified diene rubber.

### Method of Producing Rubber Composition

The method of producing the rubber composition of the present invention is not particularly limited, and specific examples thereof include a method whereby each of the above-mentioned components is kneaded using a publicly known method and device (e.g. Banbury mixer, kneader, and roller). When the rubber composition of the present invention further contains sulfur or a vulcanization accelerator, the components other than the sulfur and the vulcanization accelerator are preferably blended first (e.g. blended at 60 to 160° C.) and cooled, and then the sulfur and the vulcanization accelerator are blended thereto.

In addition, the rubber composition of the present invention can be vulcanized or crosslinked under conventional, publicly known vulcanizing or crosslinking conditions.

### Pneumatic Tire

The pneumatic tire of the present invention is a pneumatic tire that includes the rubber composition of the present invention described above. In particular, a pneumatic tire that includes the rubber composition of the present invention in, for example, a tire tread (specifically, for example, a cap tread) is preferable.

That is, the pneumatic tire of the present invention needs to be a pneumatic tire having a constituent member formed from the rubber composition of the present invention. Examples of the constituent member, formed from the rubber composition of the present invention, of pneumatic tires include tire treads, and specific examples thereof include cap treads.

The pneumatic tire of the present invention will be described below with reference to the attached drawings.

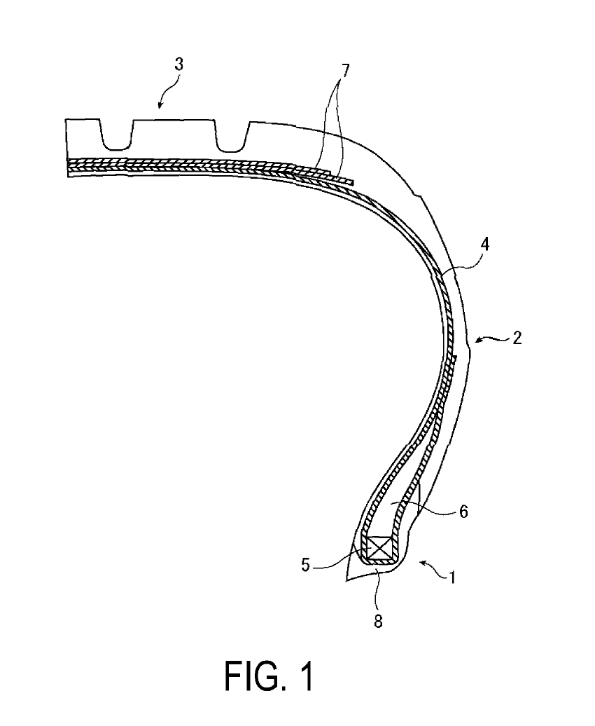

FIG. 1 is a partial cross-sectional schematic view of a tire that illustrates one embodiment of a pneumatic tire of the present invention. The pneumatic tire of the present invention is not limited to the embodiment illustrated in FIG. 1.

In FIG. 1, reference sign 1 denotes a bead portion, reference sign 2 denotes a sidewall portion, and reference sign 3 denotes a tire tread portion.

In addition, a carcass layer 4, in which a fiber cord is embedded, is mounted between a left-right pair of bead portions 1, and ends of the carcass layer 4 are wound by being folded around bead cores 5 and a bead filler 6 from an inner side to an outer side of the tire.

In the tire tread portion 3, belt layers 7 are provided along the entire circumference of the tire on the outer side of the carcass layer 4.

Additionally, rim cushions 8 are provided in parts of the bead portions 1 that are in contact with a rim.

The pneumatic tire of the present invention can be produced, for example, in accordance with conventionally known methods. In addition to ordinary air or air with an adjusted oxygen partial pressure, inert gases such as nitrogen, argon, and helium can be used as the gas with which the tire is filled.

### Conveyor Belt

The conveyor belt of the present invention is a conveyor belt in which the rubber composition of the present invention described above is used.

That is, the conveyor belt of the present invention needs to be a conveyor belt having a constituent member formed from the rubber composition of the present invention.

Examples of the conveyor belt of the present invention include a conveyor belt having at least a cover rubber layer and a reinforcing layer as constituent members. The cover rubber layer may be separated into an upper cover rubber layer and a lower cover rubber layer. In this case, for example, a reinforcing layer maybe arranged in between the upper cover rubber layer and the lower cover rubber layer.

The rubber composition of the present invention can be used in at least one type selected from the group consisting of cover rubber layers and reinforcing layers.

The conveyor belt of the present invention is not particularly limited as long as the conveyor belt includes the rubber composition of the present invention.

Examples of the method of producing the conveyor belt of the present invention include conventionally known methods.

Articles that can be transported by the conveyor belt of the present invention are not particularly limited. Furthermore, the conveyor belt of the present invention may be a conveyor belt for industrial use.

### EXAMPLES

The present invention is described below in detail using examples, but the present invention is not limited to such examples.

### Synthesis of Hydroxy Group-Containing Nitrone Compound 1

In a 2 L eggplant-shaped flask, methanol heated to 40° C. (900 mL) was charged, and then 4-hydroxybenzaldehyde represented by Formula (b) below (25.0 g) was added and dissolved thereto. To the solution, a solution in which phenylhydroxylamine represented by Formula (a) below (23.0 g) was dissolved in methanol (100 mL) was added and stirred at room temperature for 17 hours. After the completion of stirring, a hydroxy group-containing nitrone compound represented by Formula (c) below (hydroxy nitrone: N-phenyl-α-(4-hydroxyphenyl)nitrone) was obtained by recrystallization from methanol (39.3 g). The yield was 90%. The obtained compound was used as the hydroxy group-containing nitrone compound 1.

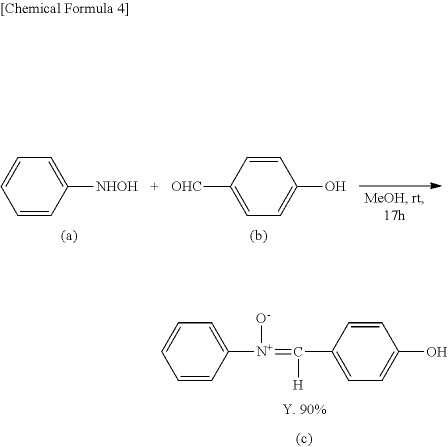

### Synthesis of Diphenylnitrone

In a 300 mL eggplant-shaped flask, benzaldehyde represented by Formula (6) below (42.45 g) and ethanol (10 mL) were charged, and then a solution in which phenylhydroxylamine represented by Formula (5) below (43.65 g) was dissolved in ethanol (70 mL) was added thereto and stirred at room temperature for 22 hours. After the completion of stirring, a nitrone compound (65.40 g) represented by Formula (7) below was obtained as white crystal by recrystallization from ethanol. The yield was 83%. The obtained nitrone compound was used as the diphenylnitrone. The diphenylnitrone contained no hydroxy group.

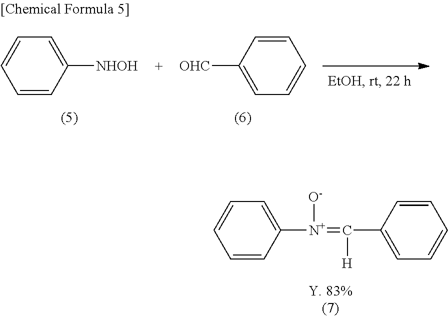

### Production of Modified Diene Rubber 1

By mixing 137.5 parts by mass of styrene butadiene rubber (E581, manufactured by Asahi Kasei Chemicals Corporation; oil extended product; oil extender content relative to the total amount of the product: 27.3 mass %; hereinafter the same) and the hydroxy group-containing nitrone compound 1 produced as described above (1 part by mass) for 5 minutes using a mixer (160° C.), a modified diene rubber 1 in which the SBR was modified with the hydroxy group-containing nitrone compound 1 was obtained. With the hydroxy group-containing nitrone compound 1, 0.18 mol % of the double bonds contained in the SBR were modified into hydroxy groups. The oil extender content of the modified diene rubber 1 was 27.3 mass % relative to the total amount of the obtained modified diene rubber 1 (oil extended state).

### Production of Comparative Modified Diene Rubber 1

An SBR modified with diphenylnitrone was produced in the same manner as for the modified diene rubber 1 except for using the diphenylnitrone (1 part by mass) produced as described above in place of the hydroxy group-containing nitrone compound 1. The obtained modified diene rubber was used as the comparative modified diene rubber 1.

### Degree of Modification of Comparative Modified Diene Rubber 1

Using a differential scanning calorimetry (DSC; DSC823e, manufactured by Mettler Toledo), the glass transition temperature (unit: ° C.) was measured by heating the comparative modified diene rubber 1 at a rate of temperature increase of 10° C./min from −130° C. to 40° C.

The inventors of the present invention had found that the degree of modification of diphenylnitrone (unit: mol %) and the rate of change in glass transition temperature (Tg) are proportional, and based on this finding, the degree of modification (mol %) of the comparative modified diene rubber 1 was determined using the following equation.

Degree of modification=ΔTg/3.6

In the formula, ΔTg is determined as follows.

ΔTg=Tg of modified diene rubber by diphenylnitrone−Tg of diene rubber used as the raw material

### Preparation of Rubber Composition

A rubber composition was produced using the components shown in Table 3 with the compositions shown in Tables 1-1 and 1-2 (part by mass). Specifically, the components shown in Tables 1-1 and 1-2 below except for sulfur and vulcanization accelerators were first mixed in a Banbury mixer at 80° C. for 5 minutes to obtain a mixture. Thereafter, the sulfur and the vulcanization accelerator were added and mixed to the mixture using a roll to obtain a rubber composition.

The same operation was also performed for Table 2.

### Production of Vulcanized Rubber Sheet

A vulcanized rubber sheet was produced by press-vulcanizing the (unvulcanized) rubber composition prepared as described above for 20 minutes at 160° C. in a mold (15 cm×15 cm×0.2 cm).

### Evaluation

The following evaluations were performed using the vulcanized rubber sheet produced as described above. The results thereof are shown in Tables 1 and 2. Each of the evaluation results was shown as an index value, with the result of Comparative Example 1 expressed as an index value of 100.

### Elongation (Elongation at Break)

In the present invention, elongation was evaluated by elongation at break.

A No. 3 dumbbell-shaped test piece was punched out of the vulcanized rubber sheet produced as described above, and tensile test was conducted in accordance with JIS K6251 at a tensile rate of 500 mm/min. The elongation at break (E_{B}) was measured at room temperature. A larger index value indicates superior elongation at break.

### Wear Resistance

For the vulcanized rubber sheet obtained as described above, abrasion loss was measured in accordance with JIS K6264-1 2:2005 using a Lambourn abrasion tester (manufactured by Iwamoto Seisakusho) at a temperature of 20° C. and at a slip rate of 50%.

Note that the evaluation result of the wear resistance was shown as an index value which was a reciprocal of the amount of wear of each example determined with the reciprocal of the amount of wear of Comparative Example 1 as 100. A larger index value indicates smaller amount of wear and thus excellent wear resistance when a tire is formed.

### Wet Grip Performance

The loss tangent at a temperature of 0° C., tan δ (0° C.) was measured for the vulcanized rubber sheet obtained as described above using a viscoelastic spectrometer (manufactured by Toyo Seiki Seisaku-sho, Ltd.) under the following conditions: 10% initial distortion, ±2% amplitude, and 20 Hz frequency. A larger index value was evaluated as having superior wet grip performance.

TABLE 1-1

| | Comparative Examples | | | | |
|---|---|---|---|---|---|
| | 1 | 2 | 3 | 4 | 5 |
| | Compounding proportion | | | | |
| Component | (part by mass) | | | | |
| NR | 16.00 | 16.00 | 16.00 | 16.00 | 16.00 |
| SBR | 98.00 | 98.00 | 98.00 | 98.00 | 49.00 |
| BR | 13.00 | 13.00 | 13.00 | 13.00 | 13.00 |
| Modified diene rubber 1 | | | | | |
| (hydroxy modified) | | | | | |
| Comparative modified diene | | | | | 49.00 |
| rubber 1 (diphenyl modified) | | | | | |
| Carbon black | 20.00 | 20.00 | 20.00 | 20.00 | 20.00 |
| Silica | 60.00 | 60.00 | 60.00 | 60.00 | 60.00 |
| Stearic acid | 2.00 | 2.00 | 2.00 | 2.00 | 2.00 |
| Processing aid | 2.00 | 2.00 | 2.00 | 2.00 | 2.00 |
| Anti-aging agent | 3.00 | 3.00 | 3.00 | 3.00 | 3.00 |
| Wax | 1.00 | 1.00 | 1.00 | 1.00 | 1.00 |
| Silane coupling agent | 4.80 | 4.80 | 4.80 | 4.80 | 4.80 |
| Oil | 16.17 | 16.17 | 16.17 | 16.17 | 16.17 |
| Zinc oxide | 3.00 | 3.00 | 3.00 | 3.00 | 3.00 |
| Sulfur | 1.85 | 1.85 | 1.85 | 1.85 | 1.85 |
| Vulcanization accelerator | 2.30 | 2.30 | 2.30 | 2.30 | 2.30 |
| (CZ) | | | | | |
| Vulcanization accelerator | 0.65 | 0.65 | 0.65 | 0.65 | 0.65 |
| (DPG) | | | | | |
| Reactive compound 1 (adipic | | 1.20 | | | |
| acid) | | | | | |
| Reactive compound 2 (sebacic | | | 1.20 | | |
| acid) | | | | | |
| Reactive compound 3 | | | | 1.20 | |
| (terephthalic acid) | | | | | |
| Functional groups/hydroxy | — | — | — | — | — |
| group (mol) | | | | | |
| Elongation (elongation at | 100 | 101 | 99 | 93 | 98 |
| break) | | | | | |
| Wear resistance (Lambourn | 100 | 94 | 93 | 97 | 102 |
| abrasion) | | | | | |
| Wet grip performance | 100 | 98 | 96 | 97 | 99 |

TABLE 1-2

| | Examples | | | |
|---|---|---|---|---|
| | 1 | 2 | 3 | 4 |
| | Compounding proportion | | | |
| Component | (part by mass) | | | |
| NR | 16.00 | 16.00 | 16.00 | 16.00 |
| SBR | 49.00 | 49.00 | 49.00 | 49.00 |
| BR | 13.00 | 13.00 | 13.00 | 13.00 |
| Modified diene rubber 1 | 49.00 | 49.00 | 49.00 | 49.00 |
| (hydroxy modified) | | | | |
| Comparative modified diene | | | | |
| rubber 1 (diphenyl modified) | | | | |
| Carbon black | 20.00 | 20.00 | 20.00 | 20.00 |
| Silica | 60.00 | 60.00 | 60.00 | 60.00 |
| Stearic acid | 2.00 | 2.00 | 2.00 | 2.00 |
| Processing aid | 2.00 | 2.00 | 2.00 | 2.00 |
| Anti-aging agent | 3.00 | 3.00 | 3.00 | 3.00 |
| Wax | 1.00 | 1.00 | 1.00 | 1.00 |
| Silane coupling agent | 4.80 | 4.80 | 4.80 | 4.80 |
| Oil | 16.17 | 16.17 | 16.17 | 16.17 |
| Zinc oxide | 3.00 | 3.00 | 3.00 | 3.00 |
| Sulfur | 1.85 | 1.85 | 1.85 | 1.85 |
| Vulcanization accelerator (CZ) | 2.30 | 2.30 | 2.30 | 2.30 |
| Vulcanization accelerator (DPG) | 0.65 | 0.65 | 0.65 | 0.65 |
| Reactive compound 1 (adipic | | 1.20 | | |
| acid) | | | | |
| Reactive compound 2 (sebacic | | | 1.20 | |
| acid) | | | | |
| Reactive compound 3 | | | | 1.20 |
| (terephthalic acid) | | | | |
| Functional groups/hydroxy group | — | 11 | 8 | 9 |
| (mol) | | | | |
| Elongation (elongation at break) | 102 | 105 | 102 | 101 |
| Wear resistance (Lambourn | 110 | 118 | 114 | 124 |
| abrasion) | | | | |
| Wet grip performance | 101 | 103 | 104 | 107 |

As is clear from the results shown in Tables 1-1 and 1-2, Comparative Examples 2 to 4, which contained no predetermined modified diene rubber, exhibited inferior wear resistance and wet grip performance compared to those of Comparative Example 1 (which contained neither modified diene rubber nor reactive compound).

Comparative Example 5, which contained no predetermined modified diene rubber but contained a comparative modified diene rubber 1 modified with a nitrone compound having no hydroxy group in place of the predetermined modified diene rubber, could not achieve high elongation and excellent wear resistance at the same time and exhibited inferior wet grip performance compared to that of Comparative Example 1.

On the other hand, Examples 1 to 4 exhibited superior wet grip performance and wear resistance while high elongation was maintained compared to those of Comparative Example 1. Furthermore, when Examples 1 to 4 were compared, Examples 2 to 4, which further contained the reactive compound, exhibited even better wet grip performance and wear resistance than those of Example 1.

When Examples 2 to 4 were compared, Example 4, in which the reactive compound was the aromatic hydrocarbon-based compound, exhibited even better wet grip performance and wear resistance than those of Examples 2 and 3, in which the reactive compounds were the aliphatic hydrocarbon-based compounds.

Furthermore, in a case where the functional group was the carboxy group, when Examples 2 to 4 were compared regarding the molar ratio of the functional group/hydroxy group, Example 4 exhibited even better wet grip performance and wear resistance than those of Examples 2 and 3. By these, it was found that, when the molar ratio of the functional group (carboxy group)/hydroxy group was from 8.5 to 10, even better wet grip performance and wear resistance were achieved.

TABLE 2

| | Comparative | | | | | |
|---|---|---|---|---|---|---|
| | Examples | | Examples | | | |
| | 1 | 6 | 1 | 5 | 6 | 7 |
| | Compounding | | Compounding | | | |
| | proportion | | proportion | | | |
| Component | (part by mass) | | (part by mass) | | | |
| NR | 16.00 | 16.00 | 16.00 | 16.00 | 16.00 | 16.00 |
| SBR | 98.00 | 98.00 | 49.00 | 49.00 | 49.00 | 49.00 |
| BR | 13.00 | 13.00 | 13.00 | 13.00 | 13.00 | 13.00 |
| Modified diene rubber 1 | | | 49.00 | 49.00 | 49.00 | 49.00 |
| (hydroxy modified) | | | | | | |
| Carbon black | 20.00 | 20.00 | 20.00 | 20.00 | 20.00 | 20.00 |
| Silica | 60.00 | 60.00 | 60.00 | 60.00 | 60.00 | 60.00 |
| Stearic acid | 2.00 | 2.00 | 2.00 | 2.00 | 2.00 | 2.00 |
| Processing aid | 2.00 | 2.00 | 2.00 | 2.00 | 2.00 | 2.00 |
| Anti-aging agent | 3.00 | 3.00 | 3.00 | 3.00 | 3.00 | 3.00 |
| Wax | 1.00 | 1.00 | 1.00 | 1.00 | 1.00 | 1.00 |
| Silane coupling agent | 4.80 | 4.80 | 4.80 | 4.80 | 4.80 | 4.80 |
| Oil | 16.17 | 16.17 | 16.17 | 16.17 | 16.17 | 16.17 |
| Zinc oxide | 3.00 | 3.00 | 3.00 | 3.00 | 3.00 | 3.00 |
| Sulfur | 1.85 | 1.85 | 1.85 | 1.85 | 1.85 | 1.85 |
| Vulcanization accelerator (CZ) | 2.30 | 2.30 | 2.30 | 2.30 | 2.30 | 2.30 |
| Vulcanization accelerator (DPG) | 0.65 | 0.65 | 0.65 | 0.65 | 0.65 | 0.65 |
| Reactive compound 4 (epoxy) | | 3.00 | | 1.20 | 3.00 | 6.00 |
| Functional groups/hydroxy group | — | — | — | 5 | 12 | 24 |
| (mol) | | | | | | |
| Elongation (elongation at break) | 100 | 104 | 102 | 103 | 100 | 100 |
| Wear resistance (Lambourn abrasion) | 100 | 99 | 110 | 125 | 143 | 111 |
| Wet grip performance | 100 | 100 | 101 | 108 | 109 | 107 |

As is clear from the results shown in Table 2, Comparative Example 6, which contained no predetermined modified diene rubber, exhibited inferior wear resistance compared to that of Comparative Example 1.

On the other hand, Examples 1 and 5 to 7 exhibited superior wet grip performance and superior wear resistance while high elongation was maintained compared to those of Comparative Example 1.

Furthermore, when Examples 1 and 5 to 7 were compared, Examples 5 to 7, which contained the reactive compound, exhibited even better wet grip performance and wear resistance than those of Example 1.

Furthermore, in a case where the functional group was the epoxy group, when Examples 5 to 7 were compared regarding the molar ratio of the functional group/hydroxy group, Example 6 exhibited even better wet grip performance and wear resistance than those of Examples 5 and 7. By these, it was found that, when the molar ratio of the functional group (epoxy group)/hydroxy group was from 6 to 23, even better wet grip performance and wear resistance were achieved.

Details of the components shown in Tables 1-1 and 1-2 and Table 2 are as follows.

TABLE 3

| | | Product |
|---|---|---|
| Component | Manufacturer | name/compound name |
| NR | NATURAL RUBBER | TSR20 |
| SBR | ASAHI KASEI | E581, |
| | CHEMICALS | solution-polymerized |
| | CORPORATION | SBR, oil extender |
| | | content: 27.3 mass % |
| BR | Zeon Corporation | NIPOL BR 1220 |
| Modified diene | Material produced as | Oil extender |
| rubber 1 | described above | content: 27.3 mass % |
| (hydroxy modified) | | |
| Comparative | Material produced as | Oil extender |
| modified diene | described above | content: 27.3 mass % |
| rubber 1 (diphenyl | | |
| modified) | | |
| Carbon black | Tokai Carbon Co., | SEAST 9M |
| | Ltd. | |
| Silica | Rhodia Silica Korea | ZEOSIL 165GR |
| | Co., Ltd. | |
| Stearic acid | NOF Corporation | Stearic acid YR |
| Processing aid | Rhein | Aktiplast ST |
| | Chemie(Qingdao) | |
| | Ltd. | |
| Anti-aging agent | Soltia Europe | SANTOFLEX 6PPD |
| Wax | Ouchi Shinko | SANNOC |
| | Chemical Industrial | |
| | Co., Ltd. | |
| Silane coupling | Evonik Degussa | Si69 |
| agent | | |
| Oil | Showa Shell Sekiyu | Extract No. 4S |
| | KK | |
| Zinc oxide | Seido Chemical | Zinc Oxide III |
| | Industry Co., Ltd. | |
| Sulfur | Karuizawa Refinery | Oil treatment sulfur |
| | Ltd. | |
| Vulcanization | Ouchi Shinko | NOCCELER CZ-G |
| accelerator (CZ) | Chemical Industrial | |
| | Co., Ltd. | |
| Vulcanization | Sumitomo Chemical | Soxinol D-G |
| accelerator (DPG) | Co., Ltd. | |
| Reactive compound 1 | Sumitomo Chemical | Adipic acid, |
| (adipic acid) | Co., Ltd. | molecular weight: |
| | | 146 |
| Reactive compound 2 | Hokoku Co., Ltd. | Sebacic acid, |
| (sebacic acid) | | molecular weight: |
| | | 202 |
| Reactive compound 3 | Mitsubishi Chemical | Terephthalic acid, |
| (terephthalic acid) | Corporation | molecular weight: |
| | | 166 |
| Reactive compound 4 | Nippon Steel | EpotohtoYD-128, |
| (epoxy) | Chemical Co., Ltd. | bisphenol A-type |
| | | epoxy resins, |
| | | molecular weight: |
| | | 628 |

Note that, in the SBR of Table 3, 27.3 mass % of the oil extender content indicates that the oil extender content was 27.3 mass % relative to the total amount of the product (oil extended state).

### REFERENCE SIGNS LIST

1 Bead portion
2 Sidewall portion
3 Tire tread portion
4 Carcass layer
5 Bead core
6 Bead filler
7 Belt layer
8 Rim cushion

1. A rubber composition comprising a modified diene rubber, in the modified rubber, from 0.02 to 4 mol % of double bonds contained in a diene rubber being modified into hydroxy groups by reacting at least one type of diene rubber selected from the group consisting of styrene butadiene rubbers, butadiene rubbers, and nitrile butadiene rubbers with a hydroxy group-containing nitrone compound having both a hydroxy group and a nitrone group.

2. The rubber composition according to claim 1, further comprising:
a polymer containing from 10 to 90 mass % of the modified diene rubber, and
a reactive compound having a plurality of functional groups that can react with the hydroxy group contained in the modified diene rubber in each molecule; wherein
a molar ratio of the functional group to the hydroxy group contained in the modified diene rubber is from 3 to 25.

3. The rubber composition according to claim 2, wherein the functional group is at least one type selected from the group consisting of epoxy groups and carboxy groups.

4. The rubber composition according to claim 2, wherein a molecular weight of the reactive compound is 3000 or less.

5. The rubber composition according to claim 1, wherein the hydroxy group-containing nitrone compound is at least one type selected from the group consisting of
N-phenyl-α-(4-hydroxyphenyl)nitrone,
N-phenyl-α-(3-hydroxyphenyl)nitrone,
N-phenyl-α-(2-hydroxyphenyl)nitrone,
N-(4-hydroxyphenyl)-α-phenylnitrone,
N-(3-hydroxyphenyl)-α-phenylnitrone, and
N-(2-hydroxyphenyl)-α-phenylnitrone.

6. A pneumatic tire comprising the rubber composition described in claim 1.

7. A conveyor belt comprising the rubber composition described in claim 1.
